(19) United States
(12) Patent Application Publication
(10) Pub. No.: US 2024/0126599 A1
(43) Pub. Date: Apr. 18, 2024

(54) METHODS AND APPARATUS TO MANAGE WORKLOADS FOR AN OPERATING SYSTEM

(71) Applicant: Intel Corporation, Santa Clara, CA (US)

(72) Inventors: Leslie Xu, Palo Alto, CA (US); Toby Opferman, Portland, OR (US); David Bradley Sheffield, Portland, OR (US); Mukta Singh, Morgan Hill, CA (US)

(21) Appl. No.: 18/396,350

(22) Filed: Dec. 26, 2023

(51) Int. Cl. G06F 9/48

(52) U.S. Cl. CPC G06F 9/4881

(57) ABSTRACT

Systems, apparatus, articles of manufacture, and methods are disclosed to manage workloads for an operating system wherein it causes programmable circuitry to cause a task of a workload to be executed with a first processor core configuration; cause the task to be executed with a second processor core configuration; compare a first performance metric of the execution of the task with the first processor core configuration to a second performance metric of the execution with the second processor core configuration; and cause to be used one of the first processor core configuration or the second processor core configuration based on the comparison.

### FIELD OF THE DISCLOSURE

This disclosure relates generally to operating systems, and, more particularly, to methods and apparatus to manage workloads for an operating system.

### BACKGROUND

Workload scheduling refers to a system to manage a given processing job across the processing cores of an operating system. A job is comprised of a plurality of tasks that may be performed by the processing core(s) of an operating system. In some systems, an operating system may be tasked with several jobs and/or varying tasks within a job to perform. Operating systems implement various scheduling techniques from simple round-robin selection to a topology-based selection. Accordingly, schedulers may use various algorithms such as simultaneous multi-threading (SMT), modules, and caches to make scheduling decisions. These scheduling decisions may be for consolidation, distribution, or gang-based scheduling. Some scheduling schemes utilize a hybrid system for scheduling where a hardware feedback mechanism provides hints to the scheduler on preferred processors to select based on some detail concerning the type of work the previous thread required. These hardware feedback mechanisms may include information concerning the quality of service the operating system needs to provide based on the priority of tasks.

### BRIEF DESCRIPTION OF THE DRAWINGS

FIG. 1 is a block diagram of an example environment in which an example system operates to manage a workload.

FIG. 2 is a block diagram of an example implementation of the task monitor circuitry of FIG. 1.

FIGS. 3-6 are flowcharts representative of example machine readable instructions and/or example operations that may be executed, instantiated, and/or performed by example programmable circuitry to implement the task monitor circuitry of FIG. 2.

FIG. 7 is an example diagram of the workload distribution of the task monitor circuitry of FIG. 2.

FIG. 8 is a block diagram of an example processing platform including programmable circuitry structured to execute, instantiate, and/or perform the example machine readable instructions and/or perform the example operations of FIGS. 3-6 to implement the task monitor circuitry of FIG. 2.

FIG. 9 is a block diagram of an example implementation of the programmable circuitry of FIG. 8.

FIG. 10 is a block diagram of another example implementation of the programmable circuitry of FIG. 8.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

In recent years, the scheduling of workloads has become increasingly difficult. As technology diversifies, there is a need for a topology of cores to be dynamic to varying performance requirements. Some current topologies attempt to schedule around existing available topologies by basing their selection on a current set of idle processors, and reducing the selection based on the topology and externally supplied data.

To address the needs of current technologies, methods and apparatus disclosed herein may perform partitioning of existing cores in a central processing unit (CPU) utilizing a dynamic response to workloads. The topology may include a cluster of processor cores that may be individually and/or group scheduled dynamically. Therefore, to schedule on the cluster of processor cores and modify the topology a new algorithm (e.g., an interning process) may be utilized.

The architecture of the cluster of processor cores allows a core to partition itself into smaller cores and present itself as one larger super core with a very wide pipeline and high inter-process communication. The cluster of processor cores provides more dedicated resources and is larger so that even when divided the divided cores may be equivalent to cores of other topologies. In the cluster of processor cores, the cores are still sharing resources. When an entire core is utilized by a single software thread, the cluster of processor cores is utilized by a single software thread. However, once the core is split into two cores, it is operating in a dual mode so that it may run two software threads. As the cluster of processor cores has a very wide and deep core, splitting does not result in performance defects and cores may be split in various intervals (e.g., two cores, four cores, eight cores, etc.).

Further, as a workload is provided to a given processor core configuration, the algorithm may determine that another processor core configuration is optimal. Therefore, the algorithm will determine whether the cost to switch (e.g., performance penalties) between the first processor core configuration to a second processor core configuration is beneath a threshold. Selection based on the cost to switch is different from the existing static solutions of other technologies. Because of the cost to switch, intelligent selection of tasks to run on a processor core configuration allows for efficient management of workload distribution.

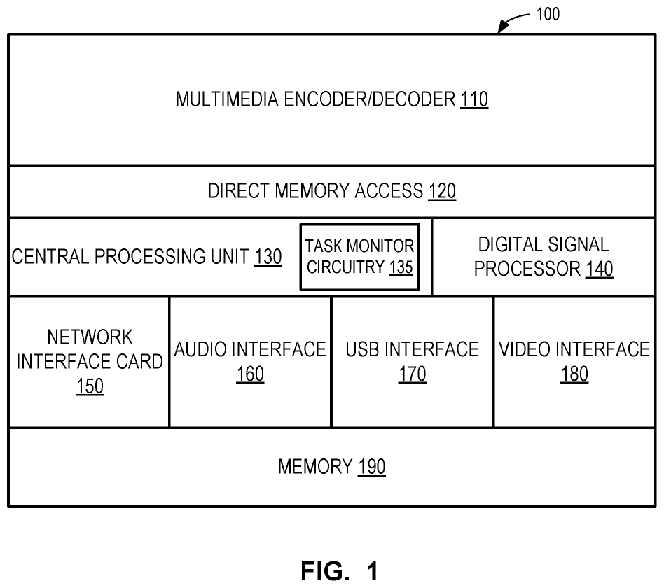

FIG. 1 is a block diagram of an example environment 100 in which an example system 100 operates to manage a workload. In the example of FIG. 1, the system 100 is a system on a chip (SoC) processing system. The system 100 of FIG. 1 is one example processing system. However, in other examples, the system 100 may be a processor, a microprocessor, a Field Programmable Gate Array (FPGA), an Application Specific Integrated Circuit (ASIC), a Microcontroller Unit (MCU), a Multi-Chip Module (MCM), a System in Package (SiP), a Graphic Processing Unit (GPU), a network processor, a Digital Signal Processor (DSP), an Intellectual Property core (IP), a homogenous multicore processor, and/or any other suitable processing system. As disclosed herein, suitable processing systems include those with processor cores. Additionally, the system 100 may be utilized by a server, an end user device, a peripheral device, and any other device that manages a workload through processor cores.

In the example of FIG. 1, the system 100 includes a multimedia encoder/decoder 110, a direct memory access 120, a central processing unit (CPU) 130, a digital signal processor 140, a network interface card 150, an audio interface 160, a USB interface 170, a video interface 180, and a memory 190.

The multimedia encoder/decoder 110 receives a data flow and converts the data flow into code. The multimedia encoder/decoder 110 receives multimedia data (such as audio and video), and compresses or decompresses the data for use by the system 100. To store data into the system 100, the multimedia encoder 110 receives the data flow and converts the data flow into a compressed format. To read the compressed data, the multimedia decoder 110 decompresses the data flow to its original format. In some examples, the multimedia encoder/decoder 110 may be instantiated by an H.264, H.265, Advanced Auto Coding (AAC), and/or an MPEG Audio Layer III (MP3). Further, while a multimedia encoder/decoder is utilized in the system 100, other compression and decompression methods may be utilized.

The direct memory access (DMA) 120 allows an input/output (I/O) device (e.g., the multimedia encoder/decoder 110) to send or receive data directly to or from the main memory, bypassing the CPU to speed up memory operations. The DMA 120 is designed to improve the efficiency of transferring data as it reduces the involvement of the CPU. While in the example of the system 100 the DMA 120 is utilized, the functionality of the DMA 120 may be instantiated alternatively by a programmed I/O (PIO), an interrupt-driven I/O, a programmable DMA, a centralized memory controller, a memory-mapped I/o, and bus mastering.

The CPU 130 controls the primary processing tasks of the system 100. The CPU 130 executes instructions stored in memory, performs arithmetic and logic operations, and manages the overall operation of the system 100. In some examples, the CPU may further include a control unit, an arithmetic logic unit, registers, and a clock. Further, the CPU may be integrated with other components of the system 100 such as memory, input/output interfaces, and specialized processing units (e.g., graphic processing units, signal processors, etc.). While, in this example, the CPU 130 is used in the system 100, the functionality associated with the CPU 130 may be further instantiated by a GPU, a DSP, a neural processing unit (NPU), an FPGA, an ASIC, and other suitable processing units. Further, the CPU 130 includes the processor cores for the system 100. In this example, the CPU 130 includes task monitor circuitry 135.

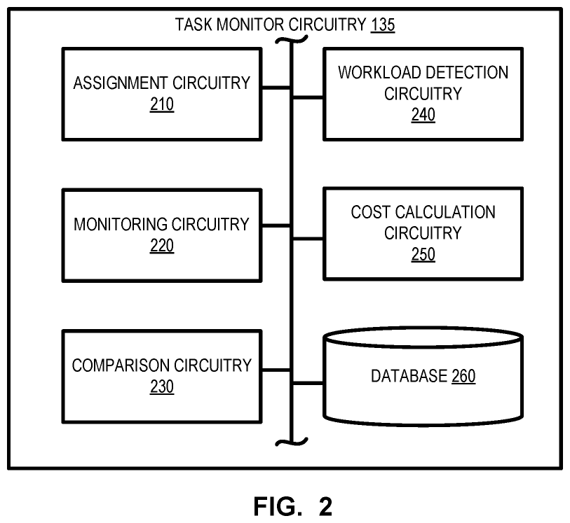

The example task monitor circuitry 135 monitors the workload for a job and distributes the workload dynamically throughout the processor cores of the CPU 130. The task monitor circuitry 135 distributes the workload dynamically by splitting processor cores to accommodate a task for the workload. In doing so, the split processor cores can accommodate more than one software thread. Further, the task monitor circuitry 135 monitors the tasks provided to a processor core configuration and calculates the performance penalty to switch processor core configurations when the type of task has changed. The task monitor circuitry 135 is described in more detail in conjunction with FIG. 2.

The digital signal processor (DSP) 140 performs signal processing operations such as data collection, data processing, etc. Further, the DSP 140 may be used to decode images, audio, video, speech, and other digital data forms. While in this example the DSP 140 is used in the system 100, the functionality associated with the DSP 140 may be further instantiated by a GPU, a CPU, a NPU, an FPGA, an ASIC, and/or any other suitable processing unit.

The network interface card 150 connects the system 100 to a network. The network interface card 150 facilitates the transmission and reception of data over a network. While in this example the network interface card 150 is used in the system 100, the functionality associated with the network interface card 150 may be further instantiated by integrated wireless connection or Bluetooth® in the system 100 directly, embedded cellular modems, software-defined radios (SDRs), external adapters (e.g., USB, PCIe, etc.), and/or any other suitable network interface devices.

External inputs from devices, such as audio, USB, or video, may input data into the system 100 through the audio interface 160, the USB interface 170, and/or the video interface 180. While in this example the interfaces 160, 170, 180 are utilized by the system 100, in other examples other interfaces such as a text interface, an image interface, or any other input data interface may be utilized.

The memory 190 stores data and operating information for the system 100. Further, the memory 190 may be instantiated by volatile (e.g., SRAM, DRAM, etc.), non-volatile memory (e.g., ROM), flash memory (e.g., NOR, NAND, etc.), cache memory, read-only memory, on-chip memory, disk storage memory, and other suitable memory devices.

FIG. 2 is a block diagram of an example implementation of the task monitor circuitry 135 of FIG. 1 to manage workloads for an operating system. The task monitor circuitry 135 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the task monitor circuitry 135 of FIG. 2 may be instantiated by (i) an ASIC and/or (ii) an FPGA structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example task monitor circuitry 135 of FIG. 1 includes example assignment circuitry 210, example monitoring circuitry 220, example comparison circuitry 230, example workload detection circuitry 240, example cost calculation circuitry 250, and example database 260.

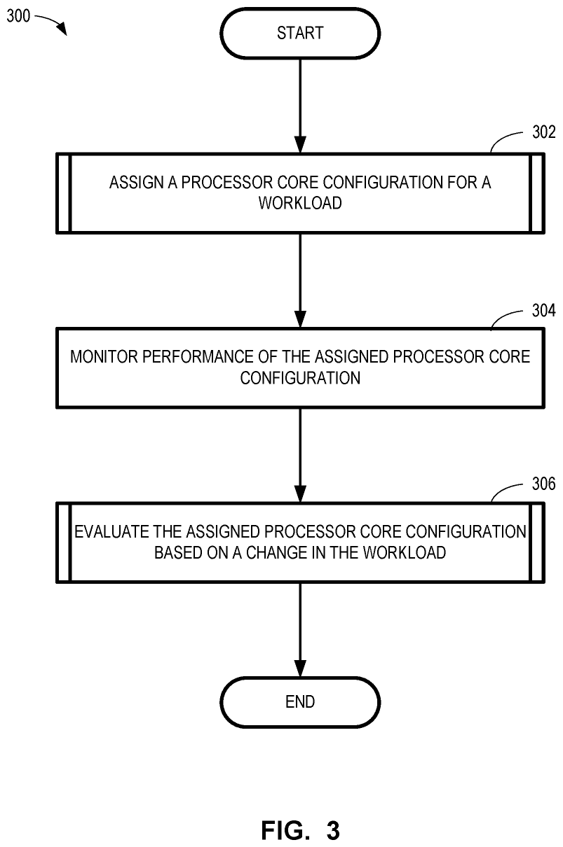

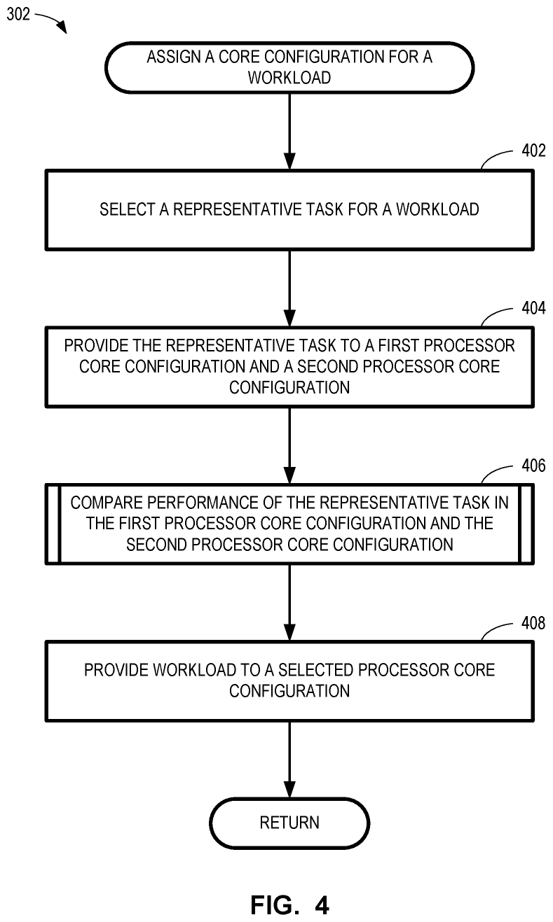

The example assignment circuitry 210 assigns a core configuration for a workload. To assign the core configuration to the workload, the assignment circuitry 210 selects a representative task for a workload, provides the representative task to a first processor core configuration and a second processor core configuration, compares performance of the task in the first processor core configuration and the second processor core configuration, and then provides the workload to a selected processor core configuration. In some examples, this selected processor core configuration may be the first processor core configuration, the second processor core configuration, or another processor core configuration. In some examples, the assignment circuitry 210 is instantiated by programmable circuitry executing assignment instructions and/or configured to perform operations such as those represented by the flowcharts of FIGS. 3-4 (blocks 302, 402-408).

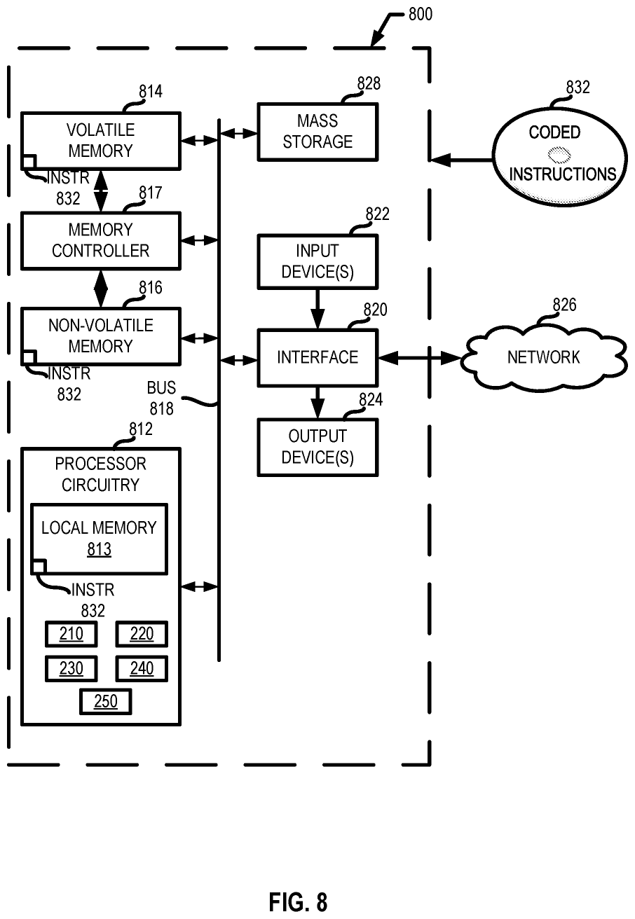

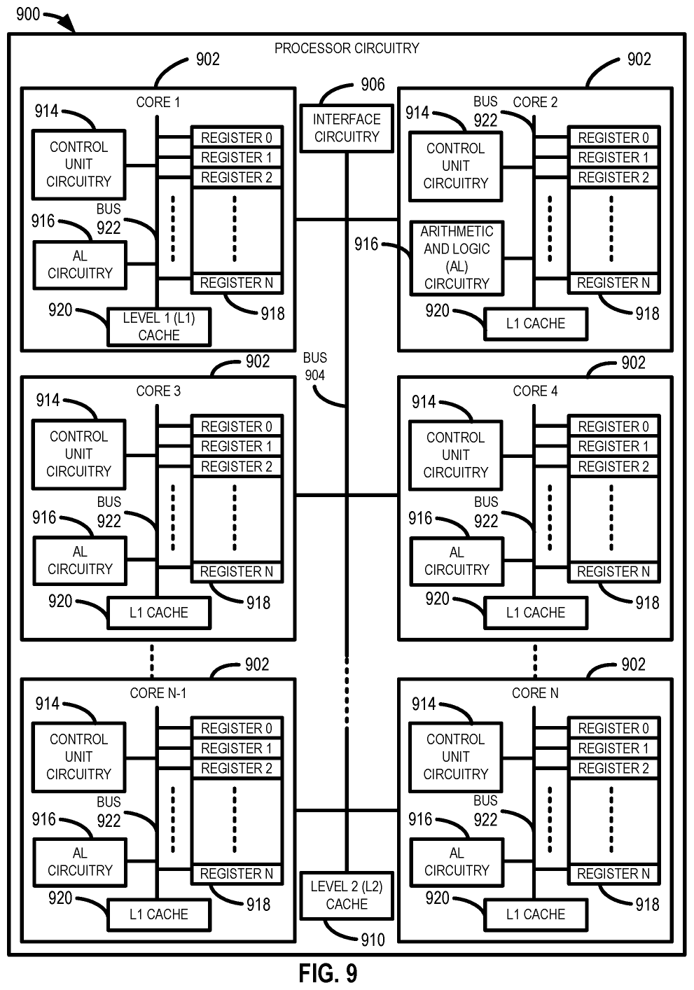

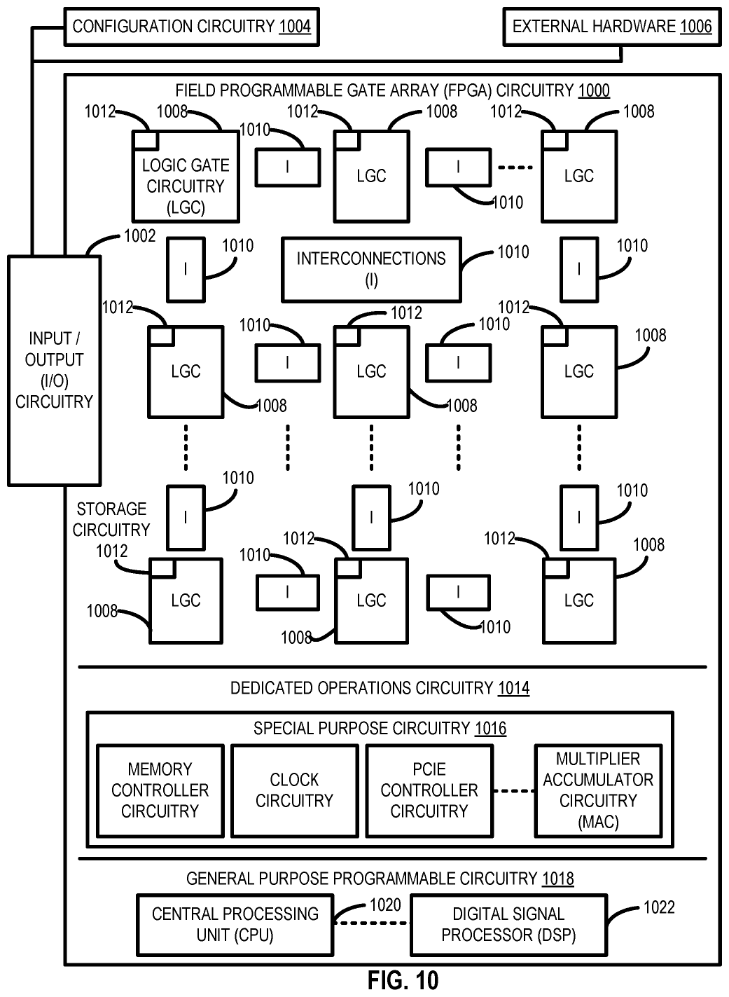

In some examples, the task monitor circuitry 135 includes means for assigning a core configuration for a workload. For example, the means for assigning may be implemented by assignment circuitry 210. In some examples, the assignment circuitry 210 may be instantiated by programmable circuitry such as the example programmable circuitry 812 of FIG. 8. For instance, the assignment circuitry 210 may be instantiated by the example microprocessor 900 of FIG. 9 executing machine executable instructions such as those implemented by at least block 302 of FIG. 3 and blocks 402-408 of FIG. 4. In some examples, the assignment circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the assignment circuitry 210 may be instantiated by any other combination of hardware, software, and/or firmware. For example, the assignment circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The monitoring circuitry 220 monitors the performance of the assigned processor core configuration. The monitoring circuitry 220 evaluates feedback concerning the performance of the selected processor core configurations and determines the suitability of the selected processor core configurations for a workload. The monitoring circuitry 220 may evaluate the performance of the selected processor core configuration by monitoring the utilization of the cores, the instructions per cycle, the CPU clock speed (e.g., frequency), power consumption, and temperature. In some examples, the monitoring circuitry 220 is instantiated by programmable circuitry executing monitoring instructions and/or configured to perform operations such as those represented by the flowchart of FIG. 3 (block 304).

In some examples, the task monitor circuitry 135 includes means for monitoring performance of the assigned processor core configuration. For example, the means for monitoring may be implemented by monitoring circuitry 220. In some examples, the monitoring circuitry 220 may be instantiated by programmable circuitry such as the example programmable circuitry 812 of FIG. 8. For instance, the monitoring circuitry 220 may be instantiated by the example microprocessor 900 of FIG. 9 executing machine executable instructions such as those implemented by at least block 304 of FIG. 3. In some examples, the monitoring circuitry 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the monitoring circuitry 220 may be instantiated by any other combination of hardware, software, and/or firmware. For example, the monitoring circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

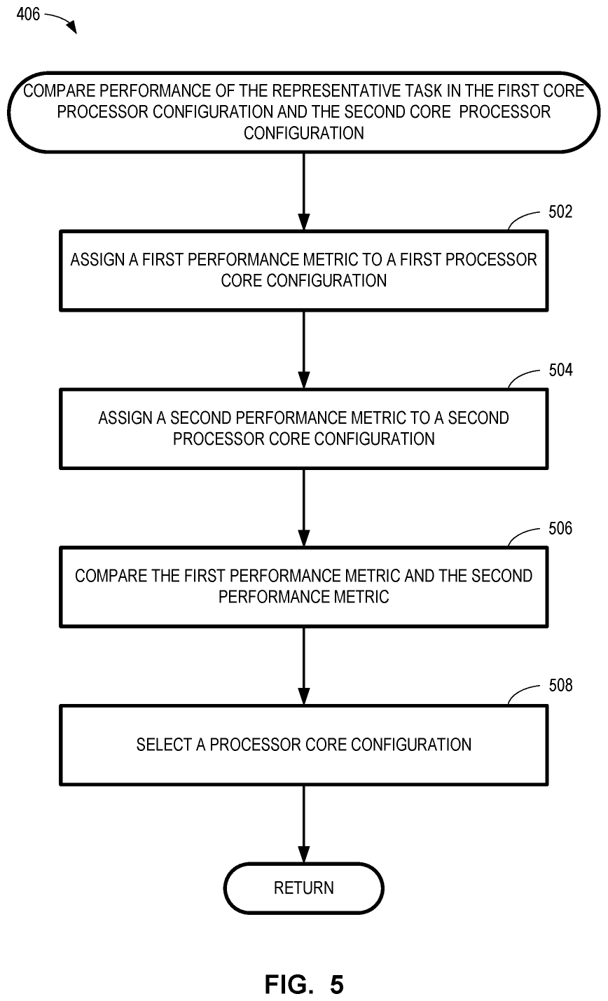

The comparison circuitry 230 compares performance of a task in a first processor core configuration to performance of the task in a second processor core configuration. To compare the performance of the task, the comparison circuitry 230 assigns a first performance metric to a first processor core configuration and a second performance metric to a second processor core configuration. Then, the comparison circuitry 230 compares the first performance metric to the second performance metric. Based on this comparison, the comparison circuitry 230 selects a processor core configuration. In some examples, the first and/or second performance metric may include data concerning the utilization of the cores, instructions per cycle, CPU clock speed (e.g., frequency), power consumption, and temperature. In some examples, the comparison circuitry 230 is instantiated by programmable circuitry executing comparison instructions and/or configured to perform operations such as those represented by the flowcharts of FIGS. 4 and 5 (block 406 and blocks 502-508).

In some examples, the task monitor circuitry 135 includes means for comparing performance of a task in a first processor core configuration to performance of the task in a second processor core configuration. For example, the means for comparing may be implemented by comparison circuitry 230. In some examples, the comparison circuitry 230 may be instantiated by programmable circuitry such as the example programmable circuitry 812 of FIG. 8. For instance, the comparison circuitry 230 may be instantiated by the example microprocessor 900 of FIG. 9 executing machine executable instructions such as those implemented by at least block 406 of FIG. 4 and blocks 502-508 of FIG. 5. In some examples, the comparison circuitry 230 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the comparison circuitry 230 may be instantiated by any other combination of hardware, software, and/or firmware. For example, the comparison circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

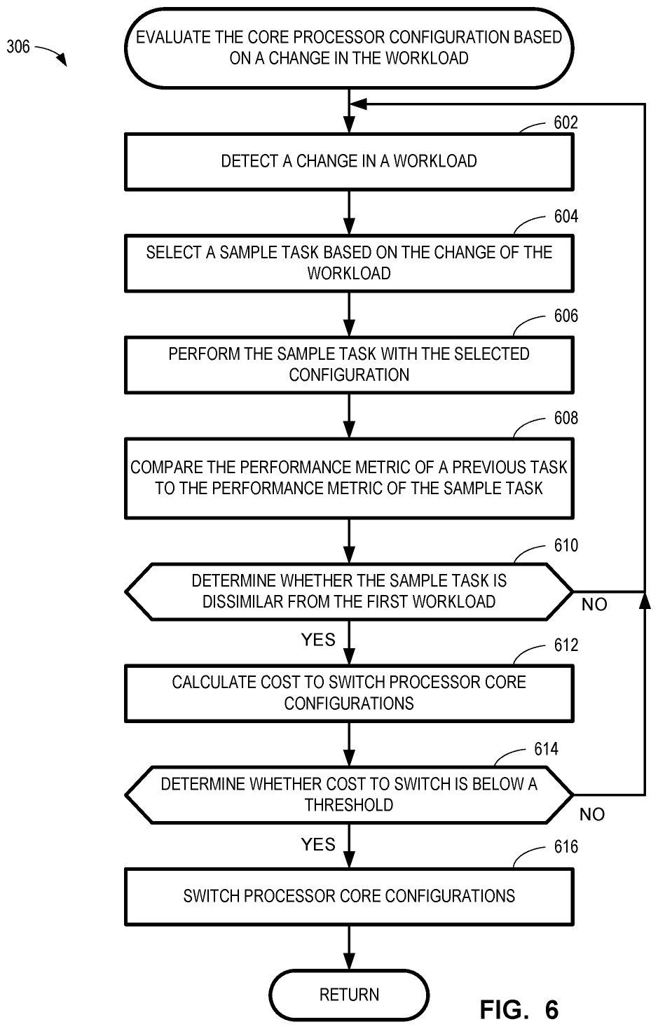

The workload detection circuitry 240 evaluates the selected processor core configuration based on a change in the workload. To evaluate the selected processor core configuration based on a change in the workload, the workload detection circuitry 240 detects a change in the workload, selects a sample task from the changed workload, performs the sample task from the changed workload with the selected processor core configuration, and compares the performance metric of a previous task of the workload prior to the detection of a change to the performance metric of the sample task from the changed workload. After this comparison, the workload detection circuitry 240 determines whether the sample task is dissimilar from the first workload. In some examples, the workload detection circuitry 240 is instantiated by programmable circuitry executing workload detection instructions and/or configured to perform operations such as those represented by the flowcharts of FIGS. 3 and 6 (block 306 and blocks 602-610).

In some examples, the task monitor circuitry 135 includes means for evaluating the processor core configuration based on a change in the workload. For example, the means for evaluating may be implemented by the workload detection circuitry 240. In some examples, the workload detection circuitry 240 may be instantiated by programmable circuitry such as the example programmable circuitry 812 of FIG. 8. For instance, the comparison circuitry 230 may be instantiated by the example microprocessor 900 of FIG. 9 executing machine executable instructions such as those implemented by at least block 306 of FIG. 3 and blocks 602-610 of FIG. 6. In some examples, the workload detection circuitry 240 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the workload detection circuitry 240 may be instantiated by any other combination of hardware, software, and/or firmware. For example, the workload detection circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The cost calculation circuitry 250 calculates the cost to switch processor core configurations. To calculate the cost to switch processor core configurations, the cost calculation circuitry 250 computes a cost function to express the difference between various processor core configurations. The cost calculation circuitry 250 calculates a cost function to express a score for the performance metrics of a given task. For example, the cost function may be:

Cₘ=w₁*m₁+w₂*m₂+ . . . +wₙ*mₙ,

wherein Cₘ is the metric cost function; w₁, w₂, w₃ are weight coefficients for performance metrics; and m₁, m₂, mₙ are the differences between the performance metric of a first processor core configuration and a second processor core configuration. Then, the cost calculation circuitry 250 calculates a final cost function by finding the difference between the metric cost function and a decay term:

C_{f}=Cₘ−C_{d},

wherein C_{d}=α^{-bk},

wherein C_{d} represents a decay term comprised of parameters (e.g., a, b, k) to prevent excessive toggling between processor core configurations. In some examples, the choice of parameters may be through parameter tuning (e.g., statistical Bayesian modeling) or by input data training (e.g., deep learning). If the cost function (C_{f}) is lowered to a threshold, the processor core configuration will be evaluated. If another processor core configuration is selected, the incoming tasks of the workload will be redirected to the new processor core configuration. In some examples, the cost calculation circuitry 250 is instantiated by programmable circuitry executing cost calculation instructions and/or configured to perform operations such as those represented by the flowcharts of FIG. 6 (blocks 612-616).

In some examples, the task monitor circuitry includes means for calculating the cost to switch processor core configurations. For example, the means for calculating may be implemented by the cost calculation circuitry 250. In some examples, the cost calculation circuitry 250 may be instantiated by programmable circuitry such as the example programmable circuitry 812 of FIG. 8. For instance, the cost calculation circuitry 250 may be instantiated by the example microprocessor 900 of FIG. 9 executing machine executable instructions such as those implemented by at least blocks 612-616 of FIG. 6. In some examples, the cost calculation circuitry 250 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the cost calculation circuitry 250 may be instantiated by any other combination of hardware, software, and/or firmware. For example, the cost calculation circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The database 260 stores information concerning instructions for the operating system and other data. The example database 260 may be implemented by magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

While an example manner of implementing the task monitor circuitry 135 of FIG. 1 is illustrated in FIG. 2, one or more of the elements, processes, and/or devices illustrated in FIG. 2 may be combined, divided, re-arranged, omitted, eliminated, and/or implemented in any other way. Further, the example assignment circuitry 210, the example monitoring circuitry 220, the example comparison circuitry 230, the example workload detection circuitry 240, the example cost calculation circuitry, the example database 260, and/or, more generally, the example task monitor circuitry 135 of FIG. 2, may be implemented by hardware alone or by hardware in combination with software and/or firmware. Thus, for example, any of the example assignment circuitry 210, the example monitoring circuitry 220, the example comparison circuitry 230, the example workload detection circuitry 240, the example cost calculation circuitry, the example database 260, and/or, more generally, the example task monitor circuitry 135, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example task monitor circuitry 135 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the task monitor circuitry 135 of FIG. 2 and/or representative of example operations which may be performed by programmable circuitry to implement and/or instantiate the task monitor circuitry 135 of FIG. 2, are shown in FIGS. 3-6. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-6, many other methods of implementing the example task monitor circuitry 135 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to manage a workload for an operating system. The example machine-readable instructions and/or the example operations 300 of FIG. 3 begin at block 302, at which the assignment circuitry 210 and comparison circuitry 230 assign a processor core configuration for a workload. An example implementation of block 302 is described in conjunction with FIG. 4. Then, at block 304, the monitoring circuitry 220 monitors the performance of the assigned processor core configuration. At block 306, the workload detection circuitry 240 and cost calculation circuitry 250 evaluate the assigned processor core configuration based on a change in the workload. An example implementation of block 306 is described in conjunction with FIG. 6.

FIG. 4 is a flowchart representative of example machine readable instructions and/or example operations 302 that may be executed, instantiated, and/or performed by programmable circuitry to assign a processor core configuration for a workload. The example machine-readable instructions and/or the example operations 302 of FIG. 4 begin at block 402, at which the assignment circuitry 210 selects a representative task for a workload. Then, at block 404, the assignment circuitry 210 provides the representative task to a first processor core configuration and a second processor core configuration. In some examples, the first processor core configuration and the second processor core configuration may be at least one of a single core processor, a dual core processor, and/or a quad core processor. At block 406, the comparison circuitry 230 compares performance of the representative task in the first processor core configuration and the second processor core configuration. An example implementation of block 406 is described in conjunction with FIG. 5. Based on this comparison, at block 408, the assignment circuitry 210 provides the workload to a selected processor core configuration. In summary, upon receipt of the workload, the operations 302 run the representative task on processor core configurations to determine the selected processor core configuration. Then, the operations 302 terminate and control returns to block 304 of FIG. 3.

FIG. 5 is a flowchart representative of example machine readable instructions and/or example operations 406 that may be executed, instantiated, and/or performed by programmable circuitry to compare performance of the representative task in the first processor core configuration and the second processor core configuration. The example machine-readable instructions and/or the example operations 406 of FIG. 5 begin at block 502, where the comparison circuitry 230 assigns a first performance metric to a first processor core configuration (block 502) and a second performance metric to a second processor core configuration (block 504). Then, at block 506, the comparison circuitry 230 compares the first performance metric and the second performance metric. As described above, this comparison is based on the difference between the scores assigned to the performance metrics and the weights given to the performance metrics. Based on this comparison, at block 508, the comparison circuitry 230 selects a processor core configuration. Then, the operations 406 terminate and control returns to block 408 of FIG. 4.

FIG. 6 is a flowchart representative of example machine readable instructions and/or example operations 306 that may be executed, instantiated, and/or performed by programmable circuitry to evaluate the processor core configuration based on a change in the workload. The example machine-readable instructions and/or the example operations 306 of FIG. 6 begin at block 602, where the workload detection circuitry 240 detects a change in the workload. In some examples, a change in the workload may be detected based on dissimilarity between a first task and a second task. In some examples, the system 100 may execute successive tasks with the same processor core configuration due to the similarity between the successive tasks. When new tasks have deviated from an original task sample over a threshold, a new process to determine a processor core configuration will be executed. After a change in the workload is detected, in block 604, the workload detection circuitry 240 selects a sample task based on the change in the workload. In block 606, the workload detection circuitry 240 sends the sample task to be executed by the selected processor core configuration. Then, at block 608, the workload detection circuitry 240 compares the performance metric of a previous task (e.g., a task from the workload before a change was detected) to the performance metric of the sample task. At block 610, the workload detection circuitry 240 determines whether the sample task is dissimilar from the first workload over a threshold amount. If the workload detection circuitry 240 determines that the sample task is dissimilar over a threshold amount from the previous task (block 610: YES), control proceeds to block 612. However, if the workload detection circuitry 240 determines that the sample task is not dissimilar over a threshold amount from the previous task (block 610: NO), control proceeds to block 602. When the workload detection circuitry 240 determines that the sample task is dissimilar over a threshold amount from the previous task, the cost calculation circuitry 250 calculates the cost to switch processor core configurations at block 612. As described above, the cost to switch processor core configurations may be calculated using the performance metrics, the weight assigned to the performance metrics, and the decay function attributed to the performance of the processor core configuration. When the cost calculation circuitry 250 determines the cost to switch processor core configurations, the cost calculation circuitry 250 determines whether the cost to switch is below a threshold (block 614). If the cost calculation circuitry 250 determines that the cost to switch is not below a threshold (block 614: NO), then control proceeds to block 602. However, if the cost calculation circuitry 250 determines that the cost to switch is below a threshold (block 614: YES), then control proceeds to block 616 where the cost calculation circuitry 250 switches the processor core configuration. When the cost calculation circuitry 250 switches the processor core configuration, control returns to block 306 of FIG. 3.

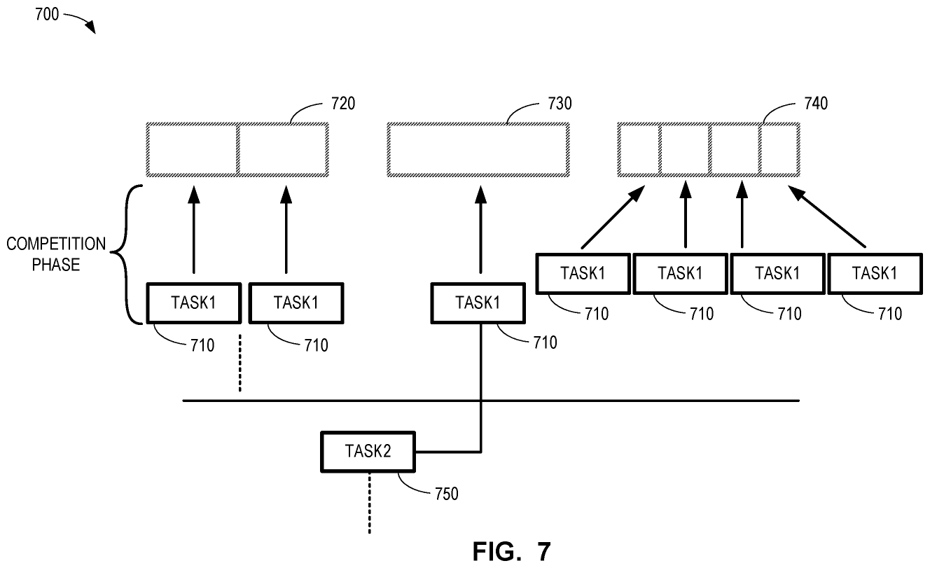

FIG. 7 is an example environment 700 executing the workload distribution algorithm of FIGS. 3-6. In this example, a representative task, Task 1 710, is polled in various processor core configurations: two cores 720, one core 730, and three cores 740. In this “COMPETITION PHASE,” the performance of the various processor core configurations 720, 730, 740 is compared by the task monitor circuitry 135. When a processor core configuration is selected, the task monitor circuitry 135 directs Task 2 750 to the selected processor core configuration. In this example, the selected processor core configuration is the one core configuration 730. However, in other examples, the selected processor core configuration may be the two core configuration 720 or the four core configuration 740. Further, in some examples, there may be other processor core configurations that are polled in the competition phase and selected (e.g., eight processor core configuration, sixteen processor core configuration, etc.).

In some examples, when a processor core configuration is selected, the same instruction snippet will continue through that configuration. In this example, Task 2 750 will be fed into the one core configuration 730 and the other instances of Task 1 710 that were run by the two cores configuration 720 and the four cores configuration 740 are thrown out. However, in other examples, Task 1 710 may be fed into the two cores configuration 720, Task 2 750 may be fed into the one core configuration 730, and a Task 3 may be fed into the four core configuration 740. When a decision of the selected processor core configuration is made, the sequential snippets will merge so that a Task 4 and the rest of the workload is then fed through the one core configuration 730 (e.g., the selected processor core configuration). In this example, the results from the two core configuration 720 and the four core configuration 740 are merged with the results for the selected processor core configuration and are not thrown away. In other examples, the task monitor circuitry 135 may create sample tasks that are similar to the actual workload and test the sample tasks throughout the various processor core configurations. Then, when a processor core configuration is selected, the sample tasks are thrown away and the workload is fed through the selected processor core configuration. In some examples, after the system 100 runs the sample tasks, there may be an interface to classify a thread to a certain processor core configuration and switch contexts.

Further, in some examples, an existing no operation (NOP) instruction can be repurposed as a hint of the processor core configuration for a type of task. Then, a compiler (e.g., the multimedia encoder/decoder 110) could identify code snippets and put them into binary code for use by the scheduler to identify or classify threads based on their execution.

FIG. 8 is a block diagram of an example programmable circuitry platform 800 structured to execute and/or instantiate the example machine-readable instructions and/or the example operations of FIGS. 3-6 to implement the task monitor circuitry of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad TM), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the assignment circuitry 210, the monitoring circuitry 220, the comparison circuitry 230, the workload detection circuitry 240, and the cost calculation circuitry 250.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 3-6, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 3-6 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 3-6.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 3-6 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-6. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6. As such, the FPGA circuitry 1000 may be configured and/or structured to effectively instantiate some or all of the operations/functions corresponding to the machine readable instructions of the flowchart(s) of FIGS. 3-6 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 3-6 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 3-6 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 3-6 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 3-6, and/or an ASIC may be configured and/or structured to perform third operation(s)/function(s) corresponding to a third portion of the machine readable instructions represented by the flowcharts of FIGS. 3-6.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that manage workloads for operating systems. Disclosed systems, apparatus, articles of manufacture, and methods improve the efficiency of using a computing device by managing the workload for an operating system by splitting cores of a CPU to dynamically adjust to a given workload. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage workloads for operating systems are disclosed herein. Further examples and combinations thereof include the following:

Example 1 includes a non-transitory computer-readable medium comprising instructions which, when executed, cause processor circuitry to cause a task of a workload to be executed with a first processor core configuration, cause the task to be executed with a second processor core configuration, compare a first performance metric of the execution of the task with the first processor core configuration to a second performance metric of the execution with the second processor core configuration, and cause to be used one of the first processor core configuration or the second processor core configuration based on the comparison.

Example 2 includes the non-transitory computer-readable medium of example 1, wherein the first processor core configuration and the second processor core configuration include at least one of a single processor core configuration, a dual processor core configuration, and a quad processor core configuration.

Example 3 includes the non-transitory computer-readable medium of example 2, wherein the processor circuitry is to configure at least one of the first processor core configuration and the second processor core configuration to run a first operation and a second operation at one time.

Example 4 includes the non-transitory computer-readable medium of example 1, wherein the processor circuitry is to assign the first performance metric a first weight and the second performance metric a second weight.

Example 5 includes the non-transitory computer-readable medium of example 4, wherein to compare the first performance metric and the second performance metric, the processor circuitry is to compare based on a difference between the first performance metric and the second performance metric.

Example 6 includes the non-transitory computer-readable medium of example 1, wherein the processor circuitry is to determine a third processor core configuration based on a detection of a new task.

Example 7 includes the non-transitory computer-readable medium of example 6, wherein the processor circuitry is to detect the new task by determining a change in the workload.

Example 8 includes the non-transitory computer-readable medium of example 7, wherein the processor circuitry is to detect a change in the workload, select a representative task of the changed workload, perform the representative task in the third processor core configuration, compare a performance metric of the execution of the representative task with the processor core configuration to a third performance metric of the execution with the third processor core configuration, and cause to be used the third processor core configuration based on the comparison.

Example 9 includes the non-transitory computer-readable medium of example 1, wherein the performance metric and the second performance metric include a utilization of a processor core, an instruction per cycle, a core processor unit clock speed, power consumption, and temperature.

Example 10 includes an apparatus to manage a workload for an operating system, the apparatus comprising machine-readable instructions, and programmable circuitry to at least one of instantiate or execute the machine-readable instructions to cause a task of the workload to be executed with a first processor core configuration, cause the task to be executed with a second processor core configuration, compare a first performance metric of the execution of the task with the first processor core configuration to a second performance metric of the execution with the second processor core configuration, and cause to be used one of the first processor core configuration or the second processor core configuration based on the comparison.

Example 11 includes the apparatus of example 10, wherein the first processor core configuration and the second processor core configuration include at least one of a single processor core configuration, a dual processor core configuration, and a quad processor core configuration.

Example 12 includes the apparatus of example 11, wherein the programmable circuitry is to configure at least one of the first processor core configuration the second processor core configuration to run a first operation and a second operation at one time.

Example 13 includes the apparatus of example 10, wherein the programmable circuity is to assign the first performance metric a first weight and the second performance metric a second weight.

Example 14 includes the apparatus of example 13, wherein to compare the first performance metric and the second performance metric, the programmable circuitry is to compare based on a difference between the first performance metric and the second performance metric.

Example 15 includes the apparatus of example 10, wherein the programmable circuitry is to determine a third processor core configuration based on a detection of a new task.

Example 16 includes the apparatus of example 15, wherein the programmable circuitry is to detect the new task by determining a change in the workload.

Example 17 includes the apparatus of example 16, wherein the programmable circuitry is to detect a change in the workload, select a representative task of the changed workload, perform the representative task in the third processor core configuration, compare a performance metric of the execution of the representative task with a processor core configuration to a third performance metric of the execution with the third processor core configuration, and cause to be used the third processor core configuration based on the comparison.

Example 18 includes the apparatus of example 10, wherein the performance metric and the second performance metric include a utilization of a processor core, an instruction per cycle, a core processor unit clock speed, power consumption, and temperature.

Example 19 includes a method to manage a workload for an operating system, the method comprising causing a task of the workload to be executed with a first processor core configuration, causing the task to be executed with a second processor core configuration, comparing a first performance metric of the execution of the task with the first processor core configuration to a second performance metric of the execution with the second processor core configuration, and causing to be used one of the first processor core configuration or the second processor core configuration based on the comparison.

Example 20 includes the method of example 19, wherein the first processor core configuration and the second processor core configuration includes at least one of a single processor core configuration, a dual processor core configuration, and a quad processor core configuration.

Example 21 includes the method of example 20, further including configuring at least one of the first processor core configuration and the second processor core configuration to run a first operation and a second operation at one time.

Example 22 includes the method of example 19, wherein the first performance metric is assigned a first weight and the second performance metric is assigned a second weight.

Example 23 includes the method of example 22, wherein the comparing is based on a difference between the first performance metric and the second performance metric.

Example 24 includes the method of example 19, further including determining a third processor core configuration based on a detection of a new task.

Example 25 includes the method of example 24, wherein the detection of the new task is determined by a change in the workload.

Example 26 includes the method of example 25, further including detecting a change in the workload, selecting a representative task of the changed workload, performing the representative task in the third processor core configuration, comparing a performance metric of the execution of the representative task with the processor core configuration to a third performance metric of the execution with the third processor core configuration, and causing to be used the third core configuration based on the comparison.

Example 27 includes the method of example 19, wherein the performance metric and the second performance metric include a utilization of a processor core, an instruction per cycle, a core processor unit clock speed, power consumption, and temperature.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A non-transitory computer-readable medium comprising instructions which, when executed, cause processor circuitry to:
cause a task of a workload to be executed with a first processor core configuration;
cause the task to be executed with a second processor core configuration;
compare a first performance metric of the execution of the task with the first processor core configuration to a second performance metric of the execution with the second processor core configuration; and
cause to be used one of the first processor core configuration or the second processor core configuration based on the comparison.

2. The non-transitory computer-readable medium of claim 1, wherein the first processor core configuration and the second processor core configuration include at least one of a single processor core configuration, a dual processor core configuration, and a quad processor core configuration.

3. The non-transitory computer-readable medium of claim 2, wherein the processor circuitry is to configure at least one of the first processor core configuration and the second processor core configuration to run a first operation and a second operation at one time.

4. The non-transitory computer-readable medium of claim 1, wherein the processor circuitry is to assign the first performance metric a first weight and the second performance metric a second weight.

5. The non-transitory computer-readable medium of claim 4, wherein to compare the first performance metric and the second performance metric, the processor circuitry is to compare based on a difference between the first performance metric and the second performance metric.

6. The non-transitory computer-readable medium of claim 1, wherein the processor circuitry is to determine a third processor core configuration based on a detection of a new task.

7. The non-transitory computer-readable medium of claim 6, wherein the processor circuitry is to detect the new task by determining a change in the workload.

8. The non-transitory computer-readable medium of claim 7, wherein the processor circuitry is to:
detect a change in the workload;
select a representative task of the changed workload;
perform the representative task in the third processor core configuration;
compare a performance metric of the execution of the representative task with the processor core configuration to a third performance metric of the execution with the third processor core configuration; and
cause to be used the third processor core configuration based on the comparison.

9. The non-transitory computer-readable medium of claim 1, wherein the performance metric and the second performance metric include a utilization of a processor core, an instruction per cycle, a core processor unit clock speed, power consumption, and temperature.

10. An apparatus to manage a workload for an operating system, the apparatus comprising:
machine-readable instructions; and
programmable circuitry to at least one of instantiate or execute the machine-readable instructions to:
cause a task of the workload to be executed with a first processor core configuration;
cause the task to be executed with a second processor core configuration;
compare a first performance metric of the execution of the task with the first processor core configuration to a second performance metric of the execution with the second processor core configuration; and
cause to be used one of the first processor core configuration or the second processor core configuration based on the comparison.

11. The apparatus of claim 10, wherein the first processor core configuration and the second processor core configuration include at least one of a single processor core configuration, a dual processor core configuration, and a quad processor core configuration.

12. The apparatus of claim 11, wherein the programmable circuitry is to configure at least one of the first processor core configuration the second processor core configuration to run a first operation and a second operation at one time.

13. The apparatus of claim 10, wherein the programmable circuity is to assign the first performance metric a first weight and the second performance metric a second weight.

14. The apparatus of claim 13, wherein to compare the first performance metric and the second performance metric, the programmable circuitry is to compare based on a difference between the first performance metric and the second performance metric.

15. The apparatus of claim 10, wherein the programmable circuitry is to determine a third processor core configuration based on a detection of a new task.

16. The apparatus of claim 15, wherein the programmable circuitry is to detect the new task by determining a change in the workload.

17. The apparatus of claim 16, wherein the programmable circuitry is to:
detect a change in the workload;
select a representative task of the changed workload;
perform the representative task in the third processor core configuration;
compare a performance metric of the execution of the representative task with a processor core configuration to a third performance metric of the execution with the third processor core configuration; and
cause to be used the third processor core configuration based on the comparison.

18. The apparatus of claim 10, wherein the performance metric and the second performance metric include a utilization of a processor core, an instruction per cycle, a core processor unit clock speed, power consumption, and temperature.

19. A method to manage a workload for an operating system, the method comprising:
causing a task of the workload to be executed with a first processor core configuration;
causing the task to be executed with a second processor core configuration;
comparing a first performance metric of the execution of the task with the first processor core configuration to a second performance metric of the execution with the second processor core configuration; and
causing to be used one of the first processor core configuration or the second processor core configuration based on the comparison.

20. The method of claim 19, wherein the first processor core configuration and the second processor core configuration includes at least one of a single processor core configuration, a dual processor core configuration, and a quad processor core configuration.

21.-27. (canceled)
